(19) United States
(12) Patent Application Publication
(10) Pub. No.: US 2021/0201186 A1
(43) Pub. Date: Jul. 1, 2021

(54) Utilizing Machine Learning to Predict Information Corresponding to Merchant Offline Presence

(71) Applicant: PAYPAL, INC., San Jose, CA (US)

(72) Inventor: Itay Margolin, Tel Aviv (IL)

(21) Appl. No.: 16/729,024

(22) Filed: Dec. 27, 2019

(51) Int. Cl. G06N 7/00; G06N 3/08; G06N 3/04; G06N 20/00; G06Q 30/02

(52) U.S. Cl. CPC G06N 7/005; G06N 3/08; G06Q 30/0201; G06N 20/00; G06N 3/0472

(57) ABSTRACT

A machine learning process includes first, second, third and fourth phases. The first phase includes accessing geographical locations and economic traits for merchants. First merchants have offline locations. Second merchants have no offline locations. The second phase includes labeling third merchants as having offline locations and labeling fourth merchants as having no offline locations. The third phase includes training a machine learning model via the economic trait data of the first, second, third, and fourth merchants. A first probability of having the offline location and a second probability of having no offline location are determined via the trained model and for each of the remaining merchants. Fifth merchants whose predicted first probability exceeds a first predefined threshold are labeled as having offline locations. Sixth merchants whose predicted second probability exceeds a second predefined threshold are labeled as having no offline locations. The fourth phase repeats the second and third phases.

### BACKGROUND

### Field of the Invention

The present invention generally relates to machine learning, and more particularly, to using machine learning to predict information corresponding to the offline presence of merchants.

### Related Art

Rapid advances have been made in the past several decades in the fields of computer technology and telecommunications. Recently, machine learning has been used to facilitate decision making in various fields without human input. However, training data may be needed in order to properly train the machine learning models. Unfortunately, in some cases, entities that wish to use machine learning to perform certain tasks may lack a sufficient amount of training data to train the models. As such, these entities may not be able to achieve accurate results using machine learning or may not be able to use machine learning at all. What is needed is an improved machine learning scheme that only needs a small amount of initial training data or lesser amounts of initial training data than currently needed.

### BRIEF DESCRIPTION OF THE FIGURES

FIG. 1 is a block diagram of a networked system according to various aspects of the present disclosure.

FIGS. 2-5 are graphs that illustrate various phases of a machine learning process according to various aspects of the present disclosure.

FIG. 6 illustrates an example computer architecture for implementing various hardware components according to various aspects of the present disclosure.

FIG. 7 illustrates an example artificial neural network according to various aspects of the present disclosure.

FIG. 8 is a simplified example of a cloud-based computing architecture according to various aspects of the present disclosure.

FIG. 9 is a flowchart illustrating a method of performing a machine learning process according to various aspects of the present disclosure.

FIG. 10 is a flowchart illustrating a method of performing a machine learning process according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to systems and methods of machine learning. Machine learning involves using machines (e.g., computer systems) to execute algorithms or statistical models to make intelligent decisions or to execute certain types of tasks without explicit instructions or involvement from humans. For example, an entity (e.g., a corporation, an organization, or a person) may use machine learning to detect and/or prevent fraud, maximize profits, predict trends or outcomes, develop customized solutions for different users, etc. However, in order for machine learning to achieve accurate and meaningful results, it may need a sufficient amount of training data (also referred to as sample data) to train the machine learning models. As a simple example, a simple machine learning task may be to detect whether an image contains a particular object. The training data for such a machine learning algorithm may include images containing the particular object and images that do not contain the particular object. If there is not a sufficient number of such types of images, then the machine learning algorithm may not be able to train the models meaningfully and as such may not be capable of making accurate decisions or predictions.

For example, an online transaction platform or a payment provider may build (or have access to) a database of its clients/customers, for example merchants. The database may contain various types of information, such as average number of transactions per year, per month, or per day, average dollar amount per transaction, category of goods or service provided, number of years in existence, a geographical location, percentage of chargebacks, online locations (e.g., the URL or website), offline locations (e.g., a physical brick-and-mortar store location), or other attributes of the merchants.

One problem facing many online transaction platforms or payment providers is that such a database may not contain all the information for every merchant. For example, the database may not have the information regarding whether or not a particular merchant has an offline presence, for example a physical brick-and-mortar store at which transactions can be conducted in person with customers. In that regard, some of the merchants may have an online presence as well as an offline presence, while other merchants may have only an online presence but no offline presence. It would be beneficial for the online transaction platform or the payment provider to have this information, so that it could perform analytics more accurately, for example with respect to fraud detection and/or prevention. While it may be desirable to use machine learning to make such a determination, the lack of available training data (e.g., verified number of merchants that have an offline presence as well as verified number of merchants that do not have an offline presence) may render the machine learning impractical.

According to various aspects of the present disclosure, the geographical location of the merchants is leveraged to effectively expand the amount of training data. For example, in a first phase of the machine learning process, available information is labeled for a group of merchants. As a part of the labeling, a small group of these merchants may have a verified offline presence, while a small group of some other merchants may have a verified no offline presence (e.g., verified to have only an online presence and does not accept customers to visit or conduct transactions in person). This may be done by a human agent in some embodiments, for example by a human agent who manually checks the digital media (e.g., a website) of a merchant to see if it advertises a physical store location in which transactions may be conducted. Meanwhile, the rest of the merchants (which may be the substantial majority) may not have either a verified offline presence or a verified lack of online presence (e.g., online-only). A goal of the present disclosure is to predict, at least in part via machine learning, whether each of the rest of these merchants has an offline presence, with only a small amount of initially available training data.

The geographical locations of each of the merchants may also be labeled for each merchant. Note that the geographical location is not necessarily equivalent to the merchant having an offline location. For example, a merchant may operate its business from a physical location and yet does not have an offline presence. The merchant may be a freelance web designer or programmer, or the merchant may sell merchandise online but lists its home address as a point of contact, or the merchant may have a warehouse for storing merchandise (which it sells online) but does not accept customers to visit or conduct transactions in person at the warehouse. In other cases, however, the listed geographical location may correspond to the offline location for the merchant. For example, the merchant may have an online store as well as a physical brick-and-mortar store, and the merchant may submit the address of the brick-and-mortar store as its geographical location, which in this case is the offline location of the merchant. For the context of the present disclosure, the online transaction platform or payment provider may know the geographical location (e.g., one that is listed in an electronic database) of the merchants but does not know whether each of the merchants has an offline presence based on the geographical location information alone.

In a second phase of the machine learning process, based on the geographical location data of the merchants, the proximity is determined between the merchants having unknown offline presence and the merchants having known offline presence or the merchants having known no-offline presence. If a merchant having an unknown offline presence is located sufficiently close (within a predetermined proximity or distance) to a merchant with a known offline presence, that merchant may be labeled as having an offline presence too. Likewise, if a merchant having an unknown offline presence is located sufficiently close to a merchant with a known no-offline presence, that merchant may be labeled as having known no-offline presence. The rationale is that, businesses are typically clustered together geographically, for example in a mall setting or a shopping center setting. Thus, if a merchant (whose offline presence is previously unknown) is located geographically close enough to a merchant that has a known offline presence, it is assumed that this merchant has an offline presence too, because it is likely located in the same mall or the same shopping center as the other merchant with the known offline presence. Conversely, if that merchant is located geographically close enough to a merchant that has a known no-offline presence, it is assumed that this merchant has no offline presence too. Based on the above, phase two effectively expands the amount of training data available for machine learning purposes.

In a third phase of the machine learning process, a machine learning model is trained. The training data comes from the merchants whose offline presence has been identified in phase one, as well as the merchants whose offline presence is determined in phase two. The expanded size of the training data means that the machine learning model may be properly trained in the third phase. The machine learning model may be trained not using the geographical location data, but using other attributes such as economic or business characteristics of the merchants, for example sales volume, sales amount, customer retention, fraud-related disputes, etc. For example, the machine learning model may examine a large amount of economic trait data associated with merchants having an offline presence or merchants not having an offline presence, which may include the merchants from both the first and second phase. Using such a trained model, probabilities are calculated for each remaining merchant (whose offline presence is still yet unknown) having an offline presence or having no-offline presence. If the calculated probability for a merchant having an offline presence exceeds a first predefined confidence threshold, that merchant is labeled as having an offline presence. Similarly, if the calculated probability for a merchant having no offline presence exceeds a second predefined confidence threshold, that merchant is labeled as having no offline presence.

In a fourth phase of the machine learning process, the second phase and the third phase may be repeated to further label the remaining merchants whose offline presence is still unknown. This process may be repeated a number of times until the offline presence status has been verified for all the merchants, or until the remaining merchants do not satisfy the geographical proximity conditions in the second phase or the confidence threshold condition in the third phase. By performing the various phases of the machine learning process, the offline presence of a plurality of merchants may be determined. Note that the same machine learning process may also extend to other aspects of conducting transactions with the merchants, for example whether the merchants accept credit cards, NFC (near field communication) payments, etc.

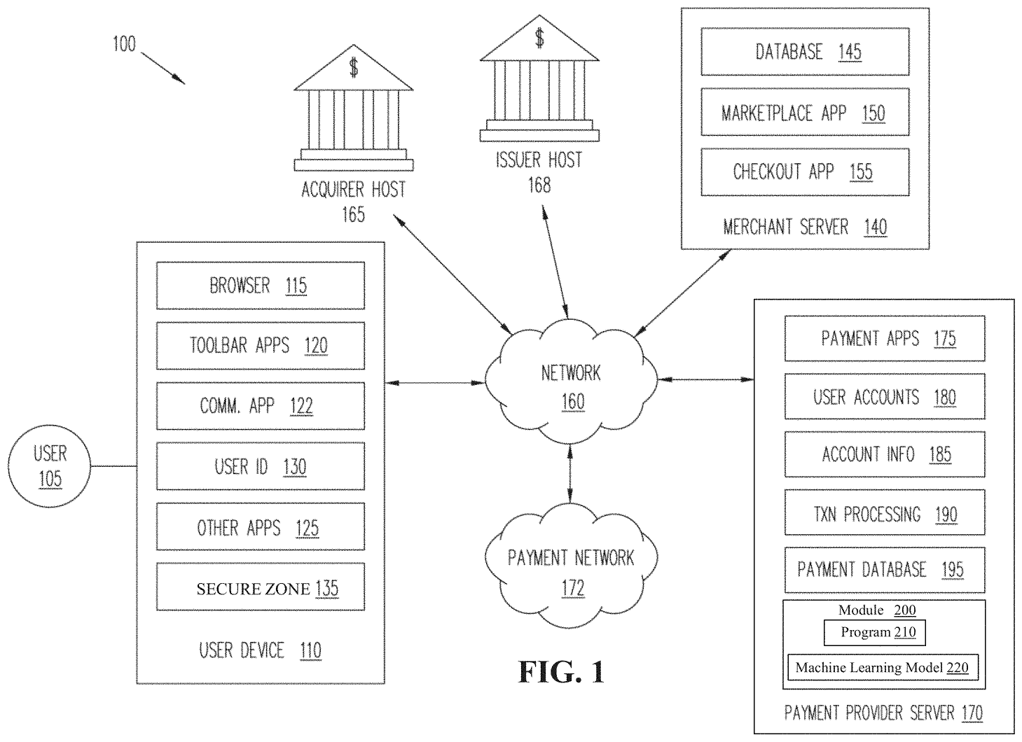

The various aspects of the present disclosure are discussed in more detail with reference to FIGS. 1-10.

FIG. 1 is a block diagram of a networked system 100 or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a server 170, an acquirer host 165, an issuer host 168, and a payment network 172 that are in communication with one another over a network 160. Server 170 may be maintained by a payment service provider, such as PAYPAL™, Inc. of San Jose, Calif. Alternatively, the server 170 may be operated by a transaction platform, such as EBAY™, Inc. of San Jose, Calif. It is understood that the payment service provider and the transaction platform are merely non-limiting examples of the types of entities that may operate the server 170. Other organizations, companies, or entities may also own and/or operate the server 170 to perform the various processes of the present disclosure.

A user 105, such as a consumer, may utilize user device 110 to perform an electronic transaction using server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an IPAD™ from APPLE™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the APPSTORE™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products and/or services. The merchant may or may not have a physical point-of-sale (POS) store front (e.g., an offline presence). The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be a payment or a gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over the network 160 to browser 115 of user device 110. In one embodiment, user 105 may interact with marketplace application 150 through browser applications over network 160 in order to view various products, food items, or services identified in database 145. The merchant server 140 may also host a website for an online marketplace, where sellers and buyers may engage in purchasing transactions with each other. The descriptions of the items or products offered for sale by the sellers may be stored in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through server 170 over network 160. For example, checkout application 155 may receive and process a payment confirmation from server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

The server 170 may be maintained, for example, by an online payment service provider which may provide payment between user 105 and the operator of merchant server 140. In this regard, server 170 may include one or more payment applications 175 which may be configured to interact with user device 110 and/or merchant server 140 over network 160 to facilitate the purchase of goods or services, communicate/display information, and send payments by user 105 of user device 110. Alternatively, as non-limiting examples, the server 170 may be maintained or operated by a transaction platform, or another type of service provider, or an ecommerce platform, etc.

The server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a module 200 may also be implemented on the server 170. The module 200 may include one or more software applications or software programs that can be automatically executed (e.g., without needing explicit instructions from a human user) to perform certain operations. For example, the module 200 may include a program 210 and a machine learning model 220. According to various aspects of the present disclosure, the module 200 completes the machine learning process in four phases. In phase one of the process, the program 210 of the module 200 may access an electronic database to retrieve the geographical location data and non-geographical-location data such as economic trait data for a plurality of merchants (e.g., merchants that own or operate the merchant server 140). The geographical location data may correspond to a physical address (or GPS coordinates) of the merchant, but it may not necessarily correspond to an offline presence (or a physical presence) of the merchant. As discussed above, a physical address of a merchant may merely be a home address/location (or some other address/location) of the merchant, from which the merchant at operates its business at least in part, but the merchant (e.g., a freelancer working from home) may not accept customers to come to such an address to conduct transactions in person. The economic trait data may include business attributes such as transaction volume, transaction amount, customer retention, risk score, etc.

As part of the phase one of the process, the program 210 of the module 200 may determine that a first subset of the merchants each have a physical presence (e.g., known to operate offline), a second subset of the merchants each have no physical presence (e.g., known to not operate offline), and a third subset of the merchants each have an unknown physical presence (e.g., uncertain whether the merchant operates offline or not).

In phase two of the process, based on the geographical location data, the program 210 of the module 200 identifies which of the merchants in the third subset (e.g., the merchants that have unknown offline locations) are within some proximity (e.g., within a predefined distance) of any of the merchants in the first subset (e.g., the merchants that have known offline locations). These merchants are then grouped into the first subset, meaning that they are deemed as having a known offline presence. Similarly, based on the geographical location data, the program 210 of the module 200 also identifies which of the merchants in the third subset are not within the proximity of any of the merchants in the second subset (e.g., the merchants that are known to have no offline locations). These merchants are then grouped into the second subset, meaning that they are deemed as having no-offline presence. These merchants that are grouped into the first subset and second subset are then removed from the third subset of the merchants.

In phase three of the process, the machine learning model 220 of the module 200 trains a machine learning model based on the economic traits of the merchants in the first subset and the second subset, including the merchants that were newly added to the first subset and the second subset (from the third subset) during phase two of the process. In this manner, the process herein effectively expands the sample size of the training data, since the first subset and the second subset (e.g., the training data) have each been enlarged as a result of phase two. In some embodiments, the geolocation data is not used in phase three of the process to train the machine learning model. In other words, in these embodiments, the machine learning model may be trained using the non-geolocation attributes of the merchants such as the economic traits alone. In other embodiments, however, geolocation data may be used (in addition to the economic traits) to assist the training of the machine learning model.

The machine learning model 220 of the module 200 also uses the trained machine learning model to determine a first probability and a second probability for each of the remaining merchants in the third subset. The first probability corresponds to the probability of having an offline presence, and the second probability corresponds to the probability of having no offline presence. If the first probability determined for a merchant exceeds a first predefined threshold, the merchant is grouped into the first subset of the merchants, meaning that such a merchant is now deemed to have an offline presence. On the other hand, if the second probability determined for a merchant exceeds a second predefined threshold, the merchant is grouped into the second subset of the merchants, meaning that such a merchant is now deemed to have no offline presence. These merchants that are grouped into the first subset and second subset are then removed from the third subset of the merchants.

In phase four of the process, the module 200 repeats phase two (for example using the program 210) and phase three (for example using the machine learning model 220) of the process one or more times. This is performed until:
1. no merchants are left in the third subset, meaning that all merchants are now labeled as having an offline presence or having no offline presence; or
2. the remaining merchants in the third subset are not within proximity of any of the merchants in the first subset and not within proximity of any of the merchants in the second subset, and the first probability of these merchants do not exceed the first predefined threshold, and the second probability of these merchants do not exceed the second predefined threshold. In other words, the remaining merchants in the third subset do not meet the conditions for being grouped into either the first subset or the second subset in either phase two or phase three of the machine learning process.

It is noted that the above actions need not be performed in four distinct phases and can be continuous or grouped accordingly as desired. It is also noted that although the module 200 is illustrated as being separate from the transaction processing application 190 in the embodiment shown in FIG. 1, the transaction processing application 190 may implement some, or all, of the functionalities of the module 200 in other embodiments. In other words, the module 200 may be integrated within the transaction processing application 190 in some embodiments. In addition, it is understood that the module 200 (or another similar module or computer program) may be implemented on another server, or even on a portable electronic device similar to the user device 110 as well. In addition, although the embodiment of FIG. 1 illustrates the program 210 and the machine learning model 220 as being separate components of the module 200, they may be integrated or merged into the same component in other embodiments. In other words, the program 210, or the machine learning model 220, may be capable of performing all phases of the machine learning process discussed above.

Still referring to FIG. 1, the payment network 172 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

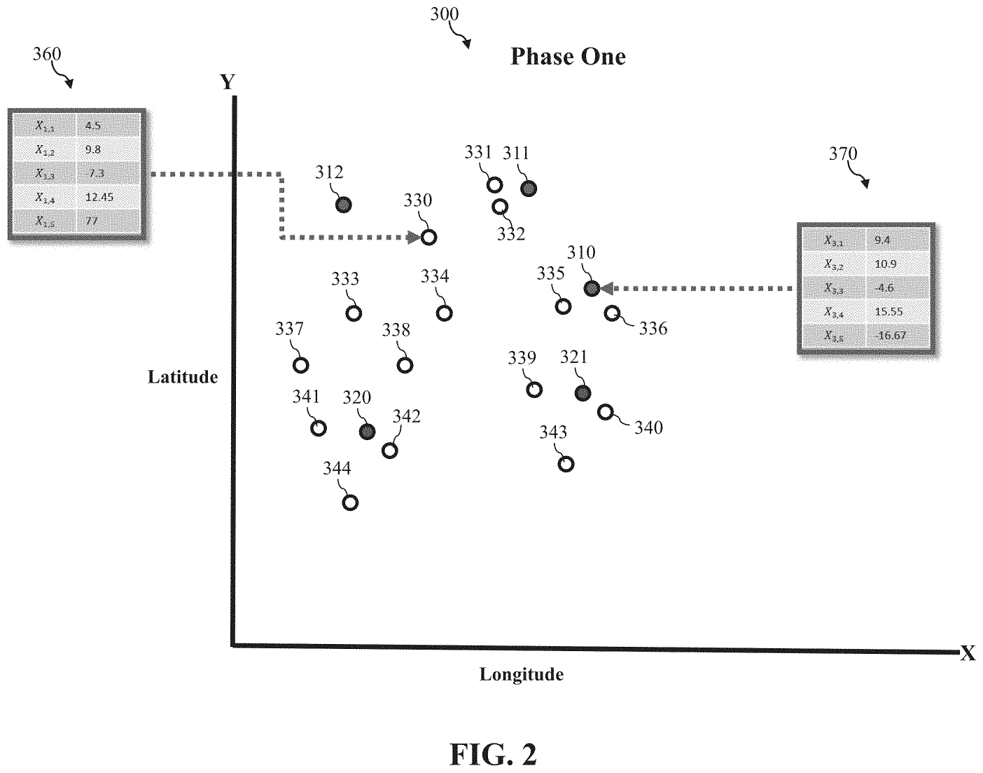

FIGS. 2-6 are graphs that visually illustrate a simplified example of phases one, two, three, and four of the machine learning process according to embodiments of the present disclosure. Referring to FIG. 2, a graph 300 visually illustrates a plurality of entities 310-312, 320-321, and 330-344 that are each represented by a point or dot. In some embodiments, the entities 310-312, 320-321, and 330-344 include merchants. In phase one, the module 200 discussed above may access an electronic database that contains data about these entities 310-312, 320-321, and 330-344 and retrieve their respective geographical location data. In that regard, the graph 300 includes an X-axis that represents the longitude of the geographical location, and a Y-axis that represents the latitude of the geographical location. As such, the geographical distribution of the entities 310-312, 320-321, and 330-344 in the graph 300 (based on the retrieved geographical location data) may correspond to their actual physical addresses (or locations measured by Global Positioning System (GPS) coordinates).

As discussed above, the geographical location data of the entities does not necessarily reveal whether any merchant has an offline presence. For example, an entity may operate its business from a location (e.g., a freelancer working from home) but does not accept clients or customers to come to that location to conduct business. As another example, an entity may list one address as the geographical location in the database but may conduct business offline from a different address. As simple examples, the entities 310, 311, and 312 are entities that have a known offline presence (e.g., having a brick-and-mortar store or a warehouse), the entities 320-321 are entities that have a known no-offline presence (e.g., does not transact business with a client/customer directly in any physical location), and the entities 330-344 are entities whose offline presence is still unknown at this point.

In some embodiments, the offline presence of the entities 310-312 may be determined by human agents. For example, one or more human agents may scour the digital media of the entities, including but not limited to websites, brochures, or advertisement materials of the entities 310-312, 320-321, and 330-344. Based on such scouring, the human agents may determine that the entities 310-312 are the entities that have offline locations at which businesses can be conducted directly with customers, the entities 320-321 are the entities that do not have offline locations at which businesses can be conducted directly with customers (even though these entities may have known geographical locations), and that the rest of the entities 330-344 are the entities that may or may not have offline locations at which businesses can be conducted directly with the customers. This process may be also referred to as a seeding process, and that the known offline presence for the entities 310-312 and the known lack off offline presence for the entities 320-321 may be referred to as ground truth data.

It is understood that although human agents may be used to perform the initial seeding of the ground truth data, computers or other machines may be employed to at least partially assist the humans (or to completely automate this part of the process) in other embodiments. For example, a computer with text and/or image recognition capabilities may be used to scan the websites of the entities 310-312, 320-321, and 330-344, including but not limited to scanning the source code of these websites. Such a scan may help determine whether the entity has an offline presence. Similarly, the code or the images of the digital advertisements or digital brochures of these entities 310-312, 320-321, and 330-344 may be scanned by machines as well.

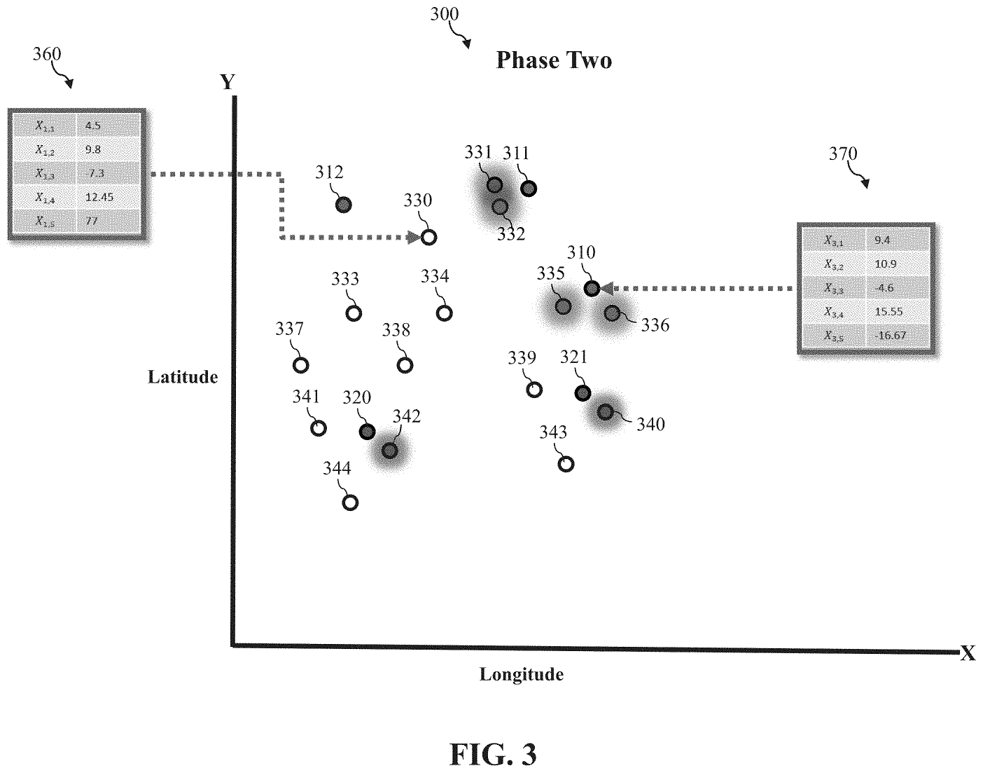

It may be said that in phase one, only the entities 310-312 and 320-321 are labeled with the presence of (or lack thereof) offline presence data. The entities 330-344 are still unlabeled in that regard. For machine learning purposes, the number of ground truth data points here (five) may not be sufficient to train the machine learning model accurately. However, this issue is addressed in phase two of the process, as discussed below in more detail with reference to FIG. 3.

Still referring to FIG. 2, the module 200 discussed above may also retrieve data pertaining to non-geographical-location attributes (e.g., economic traits or business characteristics) of the entities 310-312, 320-321, and 330-344 from the electronic database. As a simplified example, the economic trait data 360 of the entity 330 is illustrated in a box in FIG. 2, and the economic trait data 370 of the entity 310 is illustrated in another box in FIG. 2. Each box may contain a column that lists a plurality of different types of economic traits, such as X_{1,1}, X_{1,2}, X_{1,3}, X_{1,4}, and X_{1,5} for the economic trait data 360, and X_{3,1}, X_{3,2}, X_{3,3}, X_{3,4}, and X_{3,5} for the economic trait data 370. The first subscript following each X represents an entity number (out of a total number of entities). In this simplified example, the first subscript may vary from 1 to 20, since there are total of 20 illustrated entities. The second subscript following the first subscript represents the type of economic trait. For example, X_{1,1} may represent the total number of transactions for the entity 330 over the past week, X_{1,2} may represent the total monetary amount of transactions for the entity 330 over the past week, X_{1,3} may represent the increase or decrease of the number of transactions week-over-week, X_{1,4} may represent the average number of transactions for the entity 330 over the past week, X_{1,5} may represent the average monetary amount per transaction for the entity 330 over the past week, etc. Similarly, X_{3,1} may represent the total number of transactions for the entity 330 over the past week, X_{3,2} may represent the total monetary amount of transactions for the entity 330 over the past week, X_{3,3} may represent the increase or decrease of the number of transactions month-over-month, X_{3,4} may represent the average number of transactions for the entity 330 over the past week, X_{3,5} may represent the average monetary amount per transaction for the entity 330 over the past week, etc. Each box may also contain a column that lists the numerical values for these different economic trait X_{1,1}, X_{1,2}, X_{1,3}, X_{1,4}, and X_{1,5} (or X_{3,1}, X_{3,2}, X_{3,3}, X_{3,4}, and X_{3,5}).

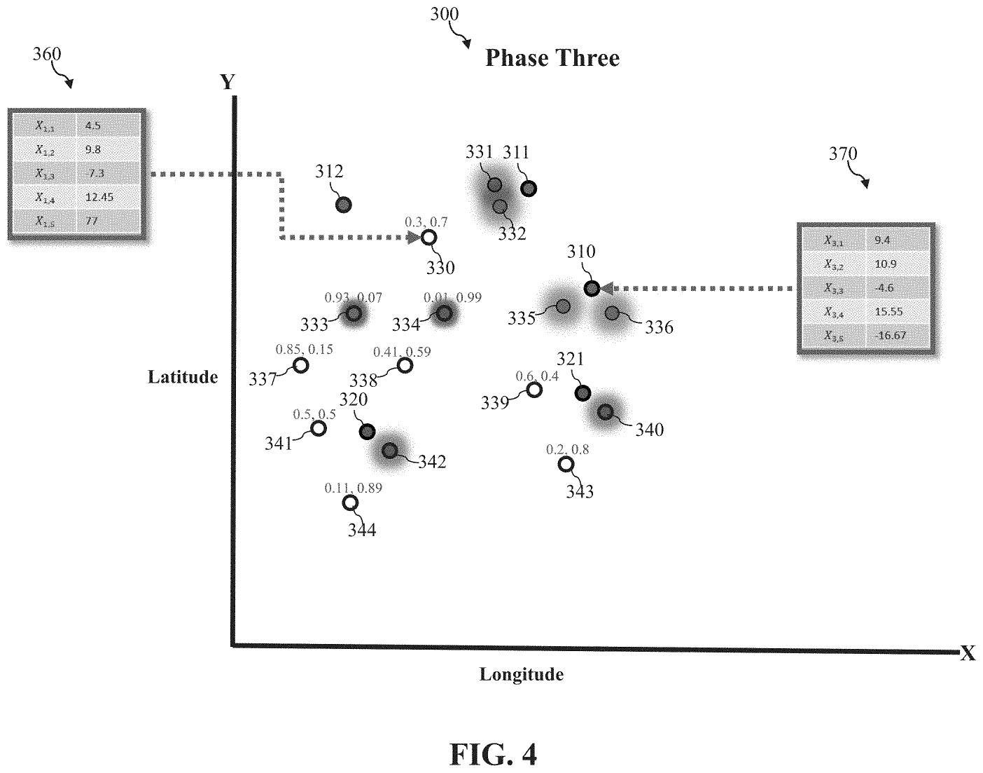

Note that each of the entities herein may have its corresponding economic trait data (similar to the data 360 or 370), but they are not specifically listed herein for reasons of simplicity. It is also understood that the attributes of the entities herein may include many more different types of data, for example categories of business, operating hours, days of closure, number of employees, number of fraud-related disputes, number of years as a client, etc. These other attributes are also not specifically listed herein for reasons of simplicity. Regardless of what types of non-geographical-location data are retrieved in phase one, such types of data will be used in phase three of the machine learning process to train the machine learning model, as discussed below in more detail with reference to FIG. 4.

Referring now to FIG. 3, the geographical proximity between the entities 330-344 (e.g., the entities that are still unlabeled with respect to their offline presence) and the entities 310-312 and 320-321 (e.g., the entities with known offline presence or the lack thereof) is determined in phase two of the machine learning process. In more detail, the machine learning process may take an entity that is still unlabeled (e.g., the entity 330) and measure the physical distances between such an entity and each of the labeled entities (e.g., the entities 310-312 and 320-321 in this case). In some embodiments, the measured distance is a haversine distance calculated according to a haversine formula. The haversine formula determines the great-circle distance between two points on a sphere given their longitudes and latitudes, which are known herein based on phase one.

The measured distance is then compared to one or more predefined distance thresholds for each of the unlabeled entities. If the measured distance is below the predefined distance threshold, the corresponding entity is deemed to be within physical proximity of the labeled entity. According to various aspects of the present disclosure, such a previously-unlabeled entity will now be grouped into the same group as the labeled entity, regardless of whether the labeled entity is the type of entity having an offline presence or the type of entity having no offline presence. This is because businesses tend to be clustered together in close proximity. As such, if an unlabeled entity whose offline presence is previously unknown is located in close proximity to a labeled entity with a known offline presence, that unlabeled entity may now be labeled as having an offline presence. In other words, such an entity is now grouped into the entities with an offline presence. Similarly, if an unlabeled entity whose offline presence is previously unknown is located in close proximity to a labeled entity whose lack of offline presence is known, that unlabeled entity may now be labeled as having no offline presence. In other words, such an entity is now grouped into the entities with no offline presence. For the other unlabeled entities that are not in proximity with any of the labeled entities, they may still be deemed as entities whose offline presence is unknown.

For example, in the case of the entity 330, it is too far from any of the other labeled entities 310-312 and 320-321. As such, the entity 330 is still deemed as having an unknown offline presence after phase two of the machine learning process is performed. However, in the case of the previously unlabeled entities 331 and 332, they are each located sufficiently close to the labeled entity 311 whose offline presence is known. Therefore, the entities 331 and 332 are presumed to be businesses that are clustered together geographically with the entity 311. According to phase two of the machine learning process herein, the entities 331 and 332 are now each labeled as having a known offline presence. For example, their offline presence (or physical location at which business may be transacted) may be the same location as the geographical location listed in the electronic database. Similarly, the previously unlabeled entities 335 and 336 are each determined to be located in sufficiently close proximity to the labeled entity 310 that has an offline presence. Accordingly, the entities 335 and 336 are now labeled as having an offline presence as well. Meanwhile, the previously unlabeled entities 342 and 340 are each determined to be located in sufficiently close proximity to the labeled entities 320 and 321, respectively. Since the entities 320 and 321 have no offline presence, the entities 342 and 340 are now labeled as having no offline presence either.

It is understood that in some embodiments, a first threshold distance is used to determine whether the entities 330-344 are located within proximity of the entities 310-312 having the offline presence, while a second threshold distance is used to determine whether the entities 330-344 are located within proximity of the entities 320-321 having no offline presence. In some embodiments, the first threshold distance is equal to the second threshold distance. In other embodiments, the first threshold distance is different from the second threshold distance. Threshold distances may vary based on the geographical area, e.g., rural business areas may have a larger threshold distance to properly include businesses that may be more spread out, as compared to densely populated urban shopping areas. The threshold distances may also vary based on population density. For example, within the same city, a more densely populated area (e.g., based on a census or a survey) may have a shorter threshold distance than a more sparsely populated area. The threshold distances may also vary based on the type of geographical area (e.g., zoning) or based on commerce statistics of the area. For example, areas with a greater amount of commercial activity may have a shorter threshold distance than areas with a lesser amount of commercial activity. It is also understood that the threshold distances may change during each iteration of phase two. For example, as will be discussed in more detail below, phase two may be repeated one or more times after phase three of the process is completed. At that point, there will be new entities that have been labeled as having known offline presences or the lack of offline presences. With the new entities having been labeled, the threshold distances in phase two may be adjusted, for example lengthened or shortened, depending on how many entities are newly labeled and what types of entities are newly labeled, etc.

After the entities 331-332 and 334-336 have been grouped into the subset of entities that have an offline presence, and the entities 340 and 342 have been grouped into the subset of entities that have no offline presence, these entities are removed from the subset of entities whose offline presence is still unknown. In this simple example shown in FIG. 3, only the entities 330, 333-334, 337-339, 341 and 343-344 still remain in the subset of entities whose offline presence is unknown after phase two of the machine learning process has been performed.

Referring now to FIG. 4, a machine learning model is trained in phase three of the process. The machine learning model may be trained using the attributes data obtained in phase one of the process, for example using the economic trait data (e.g., the data 370) of the labeled entities. As discussed above, at phase three, the entities 310-312, 331-332, and 335-336 are deemed to be the entities having an offline presence, and the entities 320-321, 340, and 342 are deemed to be the entities having no offline presence. The economic trait data for these entities may be used as the training data for the machine learning model to predict which of the remaining unlabeled entities have an offline presence. Since entities 331-332 and 335-336 are labeled as having an offline presence in phase two, and the entities 340 and 342 are labeled as having no offline presence in phase two, the size of the training data is effectively enlarged by the machine learning process of the present disclosure. As such, the machine learning model may be more accurately trained and can make better predictions. Note that the training of the machine learning model in phase three does not involve the geographical location data and may be performed using the economic trait data alone in the present embodiments, but it may be performed using the geographical location data (in addition to the economic trait data) in some other embodiments.

In some embodiments, for each of the remaining unlabeled entities, the machine learning model (after being trained) predicts a first probability for the entity having an offline presence and a second probability of the entity having no offline presence. The machine learning model may also set a first confidence threshold for the first probability and a second confidence threshold for the second probability. If the first probability exceeds the first confidence threshold, the entity is now labeled as having an offline presence. In other words, such an entity is now grouped into the subset of the entities that have an offline presence. If the second probability exceeds the second confidence threshold, the entity is labeled as having no offline presence. In other words, such an entity is now grouped into the subset of the entities that have no offline presence.

In the example shown in FIG. 4, the first confidence threshold may be set to 0.9 (90%), and the second confidence threshold may also be set to 0.9 (90%). Though the first confidence threshold and the second confidence threshold are equal to one another in this embodiment, they may be different in value in other embodiments. The machine learning model predicts that the entity 333 has a first probability of 0.93 (93%) of having an offline presence and a second probability of 0.07 (7%) of having no offline presence. Since the first probability value of 0.93 is greater than the value of 0.9 for the first confidence threshold, the entity 333 is now labeled as having an offline presence. Similarly, the predicted second probability of 0.99 for the entity 334 exceeds the second confidence threshold, the entity 334 is now labeled as having no offline presence. The entities 333 and 334 are removed from the subset of entities that have an unknown offline presence.

The remaining entities 330, 337, 338, 339, 341, 343, and 344 have predicted first probabilities of 0.3, 0.85, 0.41, 0.6, 0.5, 0.2, and 0.11, respectively, and predicted second probabilities of 0.7, 0.15, 0.59, 0.4, 0.5, 0.8, and 0.89, respectively. Since these predicted first and second probabilities are still less than the first and second confidence thresholds, respectively, the unlabeled entities 330, 337, 338, 339, 341, 343, and 344 will still remain unlabeled. In other words, it is still unknown whether or not the entities 330, 337, 338, 339, 341, 343, and 344 have an offline presence.

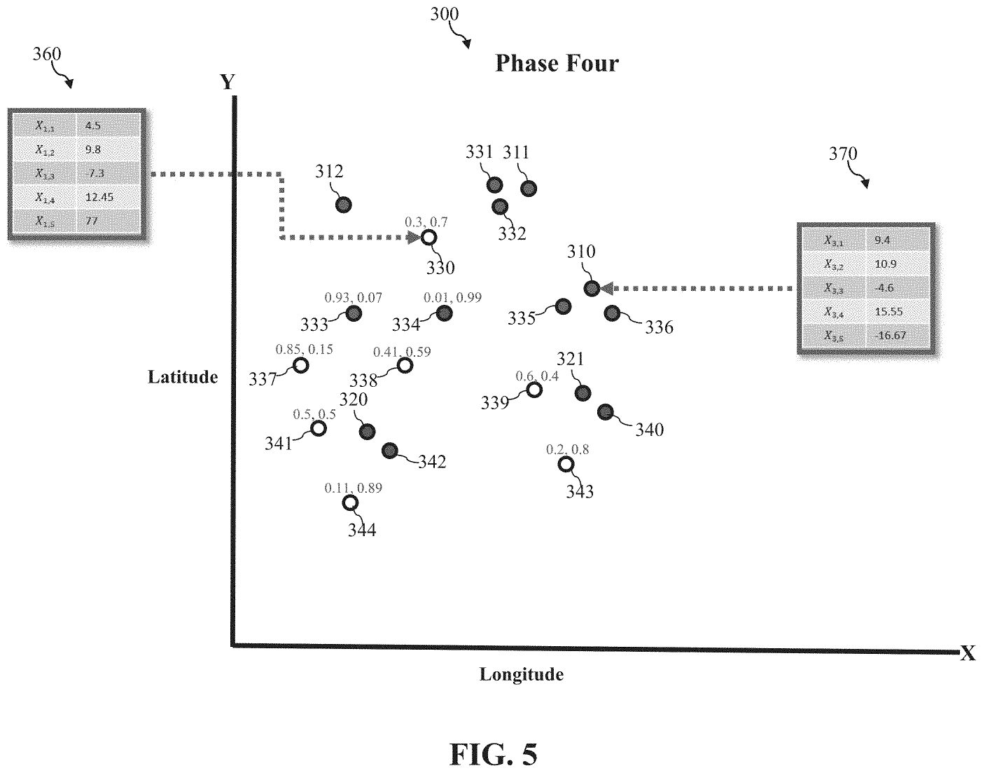

Referring now to FIG. 5, phase four of the machine learning process is performed. Phase four repeats phase two and phase three of the machine learning process. Stated differently, for the unlabeled entities 330, 337, 338, 339, 341, 343, and 344, their respective proximity (e.g., based on the haversine distance) with the labeled entities is measured, similar to what was performed in phase two discussed above with reference to FIG. 3. Since additional entities have been labeled in phase two and phase three as either having an offline presence (e.g., the entities 331-332, 335-336, and 333), or having no offline presence (e.g., the entities 340, 342, and 334), it is now possible for one or more of the remaining unlabeled entities 330, 337, 338, 339, 341, 343, and 344 to be in sufficient proximity to one of the labeled entities, such that the one or more remaining unlabeled entities may be labeled as having an offline presence or having no offline presence, similar to phase two. For example, since the entity 333 has been added as an entity with a known offline presence, and since the entity 337 and/or 338 may be in close proximity to the entity 333, the entities 337 or 338 may also be labeled as entities with a known offline presence in the repeated phase two. Likewise, the entity 343 may be located in close proximity to the labeled entity 340-which is newly labeled as having no offline presence-the entity may be labeled as having no offline presence in the repeated phase two.

After phase two is repeated, the machine learning model may be trained again as in phase three, this time with potentially additional training data (since one or more additional entities could have been labeled in the repeated phase two). The re-trained machine learning model may then be used to re-predict the first probability and second probability for each of the remaining unlabeled entities in the repeated phase three. Based on the re-predicted first and second probabilities, the remaining unlabeled entities may be labeled as having an offline presence or as having no offline presence, similar to what was done in phase three discussed above with reference to FIG. 4. For example, the entity 341 may have a re-predicted first probability of 0.95, which exceeds the first predefined confidence threshold of 0.9. Thus, the entity 341 should be labeled as having an offline presence in repeated phase three. As another example, the entity 344 may have a re-predicted second probability of 0.91, which exceeds the second predefined confidence threshold of 0.9. Thus, the entity 344 should be labeled as having no offline presence in repeated phase three.

Phase four may be performed (e.g., repeating phase two and phase three one or more times) until one of the following conditions is met:
1. there are no unlabeled entities left. In other words, all the remaining entities 330, 337, 338, 339, 341, 343, and 344 have been labeled; or
2. There are still one or more unlabeled entities left. However, any remaining unlabeled entity does not satisfy the proximity condition of phase two (e.g., still located too far from any of the labeled entities) and does not satisfy the probability threshold condition of phase three either. In other words, such an unlabeled entity cannot be labeled based on the geographical proximity in phase two, nor could it be labeled based on the probabilities predicted by the re-trained machine learning model.

Even if some entities still cannot be labeled after phase four is completed (meaning that the offline presence status is still unknown for these entities), in most cases a substantial majority of the entities will have been labeled by the various phases of the machine learning process performed herein. At least phases two, three, and four of the machine learning process is performed via machines and without human involvement, and in some embodiments the phase one may be performed via machines as well. Compared to conventional situations where a transaction platform or a payment provider may need to rely on humans to determine the offline presence status for all the entities (e.g., merchants), which is slow and error-prone, the machine learning process of the present disclosure utilizes machine learning to automate this process and makes accurate predictions. Furthermore, whereas the lack of sufficient ground truth data may make it infeasible or impractical to train a machine learning model under conventional scheme, the machine learning process of the present disclosure overcomes this problem (which is a problem specifically arising in the realm of computer technology) by leveraging the geographical location data of entities to effectively expand the ground truth data for machine learning purposes. Since the machine learning process herein does not need a large initial ground truth data pool and therefore requires less resources than conventional machine learning processes, it may be performed faster and more accurately than conventional machine learning processes. Thus, the present disclosure improves the functionality of a computer, for example a computer on which the machine learning processes are executed.

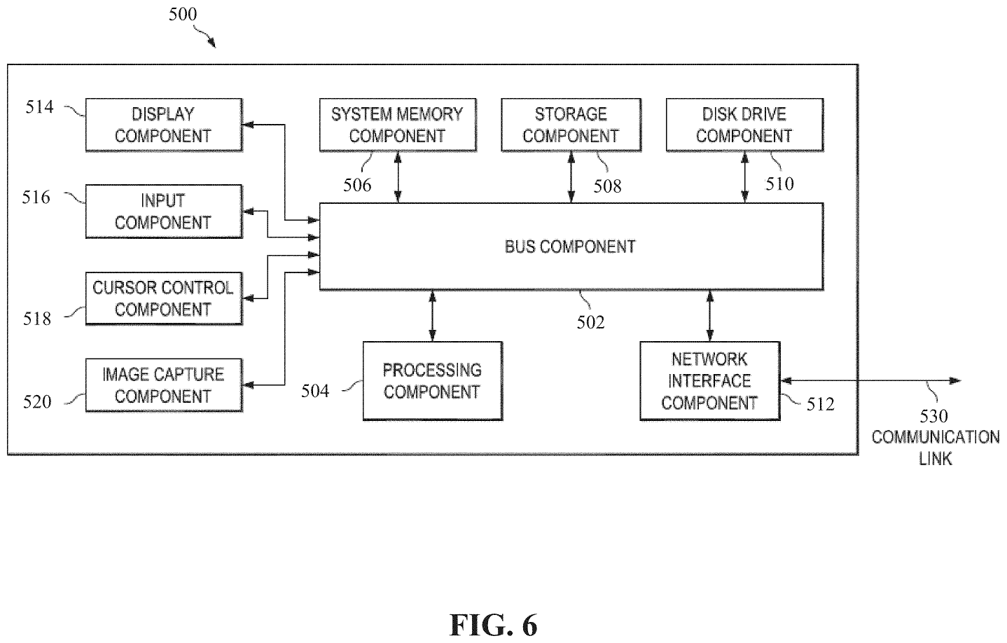

FIG. 6 is a block diagram of a computer system 500 suitable for implementing various methods and devices described herein, for example, the module 200, the user device 110, the merchant server 140, or the server 170. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the module 200 and the various method steps of the methods 900 and 1000 discussed below (or the user device 110, the merchant server 140, or the server 170) may be implemented as the computer system 500 in a manner as follows.

In accordance with various embodiments of the present disclosure, the computer system 500, such as a network server or a mobile communications device, includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure. In some embodiments, the various components of the module 200 may be in the form of software instructions that can be executed by the processor 504 to automatically perform context-appropriate tasks on behalf of a user.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the module 200 discussed above.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by computer processor 504 as received and/or stored in disk drive component 510 or some other non-volatile storage component for execution. The communication link 530 and/or the communication interface 512 may be used to conduct electronic communications between the module 200 and external devices, for example with the user device 110, with the merchant server 140, or with the server 170, depending on exactly where the module 200 is implemented.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the module 200 may be implemented as such software code.

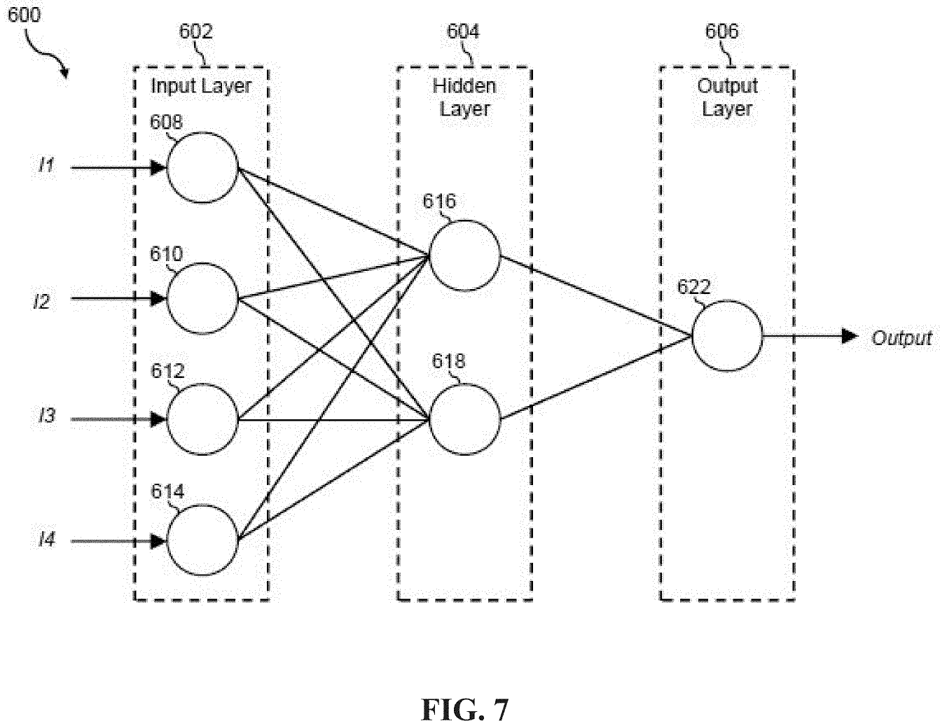

It is understood that machine learning process discussed above may be performed at least in part via an artificial neural network. In that regard, FIG. 7 illustrates an example artificial neural network 600. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement the module 200, (for example the machine learning model 220) and the module 200 may include as many hidden layers as necessary.

In this example, the artificial neural network 600 receives a set of input values and produces an output value. Each node in the input layer 602 may correspond to a distinct input value. For example, when the artificial neural network 600 is used to implement the module 200, each node in the input layer 602 may correspond to a distinct attribute or a specific type of economic trait of a merchant.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the module 200, the output value produced by the artificial neural network 600 may indicate a likelihood of an event (e.g., a dispute event, a chargeback event, etc.) associated with the transaction. In some embodiments, the output value produced by the artificial neural network 600 may predict a probability of a specific merchant having an offline presence, or the specific merchant having no offline presence (e.g., the merchant operates only online).

The artificial neural network 600 may be trained by using training data. Again, as discussed above, the present disclosure effectively expands the size of the training data by leveraging the available geographical location data, for example according to phase two of the machine learning process. By providing training data to the artificial neural network 600, the nodes 616-618 in the hidden layer 604 may be trained (adjusted) such that an optimal output (e.g., accurately predicting the probability of a merchant having an offline presence) is produced in the output layer 606 based on the training data. By continuously providing different sets of training data, and penalizing the artificial neural network 600 when the output of the artificial neural network 600 is incorrect (e.g., when the determined (predicted) likelihood is inconsistent with whether the event actually occurred for the transaction, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

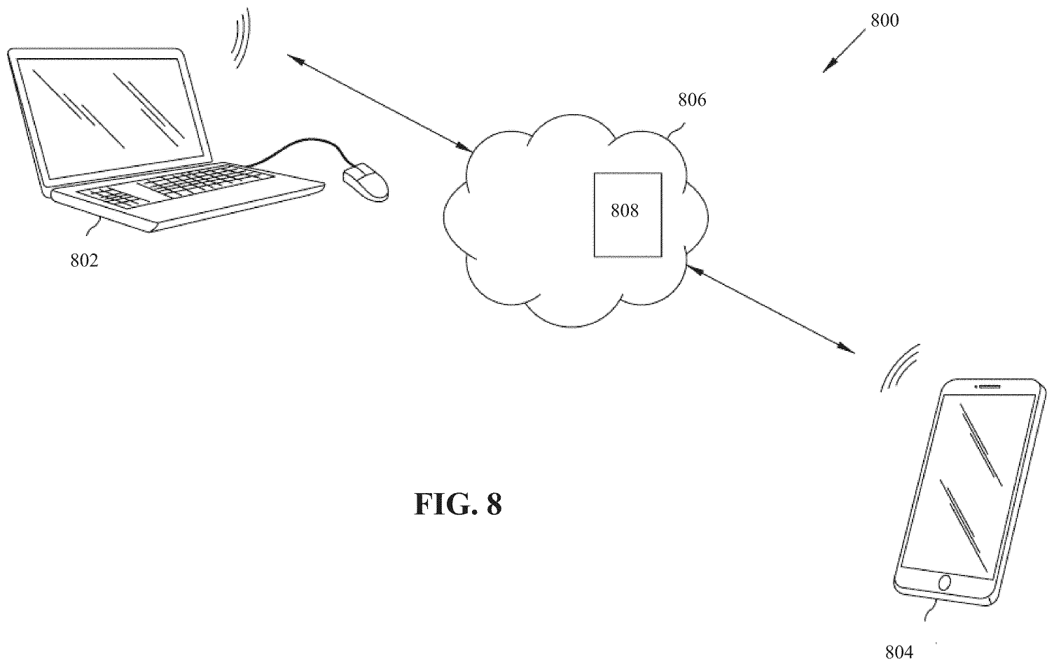

FIG. 8 illustrates an example cloud-based computing architecture 800, which may also be used to implement various aspects of the present disclosure. The cloud-based computing architecture 800 includes a mobile device 804 (e.g., the user device 110 of FIG. 1) and a computer 802 (e.g., the merchant server 140 or the server 170), both connected to a computer network 806 (e.g., the Internet or an intranet). In one example, a consumer has the mobile device 804 that is in communication with cloud-based resources 808, which may include one or more computers, such as server computers, with adequate memory resources to handle requests from a variety of users. A given embodiment may divide up the functionality between the mobile device 804 and the cloud-based resources 808 in any appropriate manner. For example, an app on mobile device 804 may perform basic input/output interactions with the user, but a majority of the processing may be performed by the cloud-based resources 808. However, other divisions of responsibility are also possible in various embodiments. In some embodiments, using this cloud architecture, the module 200 may reside on the merchant server 140 or the server 170, but its functionalities can be accessed or utilized by the mobile device 804, or vice versa.

The cloud-based computing architecture 800 also includes the personal computer 802 in communication with the cloud-based resources 808. In one example, a participating merchant or consumer/user may access information from the cloud-based resources 808 by logging on to a merchant account or a user account at computer 802. The machine learning as discussed above may be implemented at least in part based on the cloud-based computing architecture 800.

It is understood that the various components of cloud-based computing architecture 800 are shown as examples only. For instance, a given user may access the cloud-based resources 808 by a number of devices, not all of the devices being mobile devices. Similarly, a merchant or another user may access the cloud-based resources 808 from any number of suitable mobile or non-mobile devices. Furthermore, the cloud-based resources 808 may accommodate many merchants and users in various embodiments.

It should be appreciated that like reference numerals are used to identify like elements illustrated in one or more of the figures, wherein these labeled figures are for purposes of illustrating embodiments of the present disclosure and not for purposes of limiting the same.

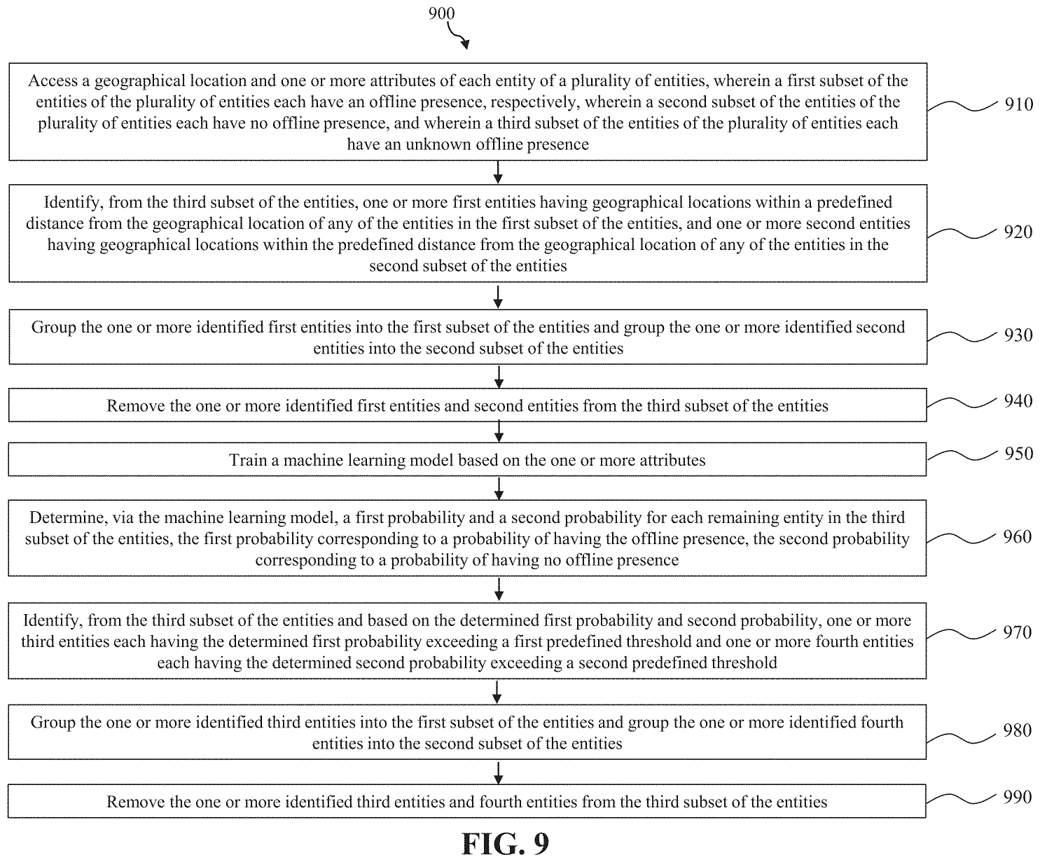

FIG. 9 is a flowchart illustrating a method 900 for performing a machine learning process according to various aspects of the present disclosure. The various steps of the method 900 may be performed by one or more electronic processors. In some embodiments, at least some of the steps of the method 900 may be performed by the module 200 discussed above. Further, for conciseness, not all details associated with the steps below are included, as such details are discussed above, and thus, the steps described below include suitable descriptions above.

The method 900 includes a step 910 to access a geographical location and one or more attributes of each entity of a plurality of entities. A first subset of the entities of the plurality of entities each have an offline presence, respectively. A second subset of the entities of the plurality of entities each have no offline presence. A third subset of the entities of the plurality of entities each have an unknown offline presence.

The method 900 includes a step 920 to identify, from the third subset of the entities and based on the accessing step of 910, one or more first entities having geographical locations within a predefined distance from the geographical location of any of the entities in the first subset of the entities, and one or more second entities having geographical locations within the predefined distance from the geographical location of any of the entities in the second subset of the entities.

The method 900 includes a step 930 to group the one or more identified first entities into the first subset of the entities and to group the one or more identified second entities into the second subset of the entities.

The method 900 includes a step 940 to remove the one or more identified first entities and second entities from the third subset of the entities.

The method 900 includes a step 950 to train a machine learning model based on the one or more attributes.

The method 900 includes a step 960 to determine, via the machine learning model, a first probability and a second probability for each remaining entity in the third subset of the entities. The first probability corresponds to a probability of having the offline presence. The second probability corresponds to a probability of having no offline presence.

The method 900 includes a step 970 to identify, from the third subset of the entities and based on the determined first probability and second probability, one or more third entities each having the determined first probability exceeding a first predefined threshold and one or more fourth entities each having the determined second probability exceeding a second predefined threshold.

The method 900 includes a step 980 to group the one or more identified third entities into the first subset of the entities and to group the one or more identified fourth entities into the second subset of the entities.

The method 900 includes a step 990 to remove the one or more identified third entities and fourth entities from the third subset of the entities.

In some embodiments, the step 910 comprises retrieving data pertaining to the geographical location and the one or more attributes from an electronic database.

In some embodiments, the plurality of entities comprises a plurality of merchants that each have at least an online presence.

In some embodiments, the offline presence is a physical location of a respective merchant of the plurality of merchants at which at least some transactions are conducted in person with customers of the respective merchant.

In some embodiments, the training is based on the one or more attributes of the first subset of the entities and the second subset of the entities but not based on the one or more attributes of the third subset of the entities.

In some embodiments, the first predefined threshold is equal to the second predefined threshold.

In some embodiments, the one or more attributes comprise economic traits of each of the plurality of entities.

In some embodiments, at least the step 950 of training the machine learning model is performed by one or more hardware processors.

It is understood that additional method steps may be performed before, during, or after the steps 910-990 discussed above. For example, the method 900 may include steps that are performed before the one or more first entities are identified. These steps may include a step to determine, via digital media of the first subset of the entities, that the first subset of entities each have the offline presence. These steps may also include a step to determine, via digital media of the second subset of the entities, that the second subset of entities each have no offline presence. These steps may also include a step to determine, via one or more humans, that the first subset of entities each have the offline presence or that the second subset of entities each have no offline presence.

As another example, the method 900 may repeat the steps 920-990 one or more times. In some embodiments, the repeating is performed until: every entity in the third subset of the entities has been grouped into the first subset of the entities or into the second subset of the entities; or no first, second, third, or fourth entities can be identified from the third subset of the entities. For reasons of simplicity, other additional steps are not discussed in detail herein.

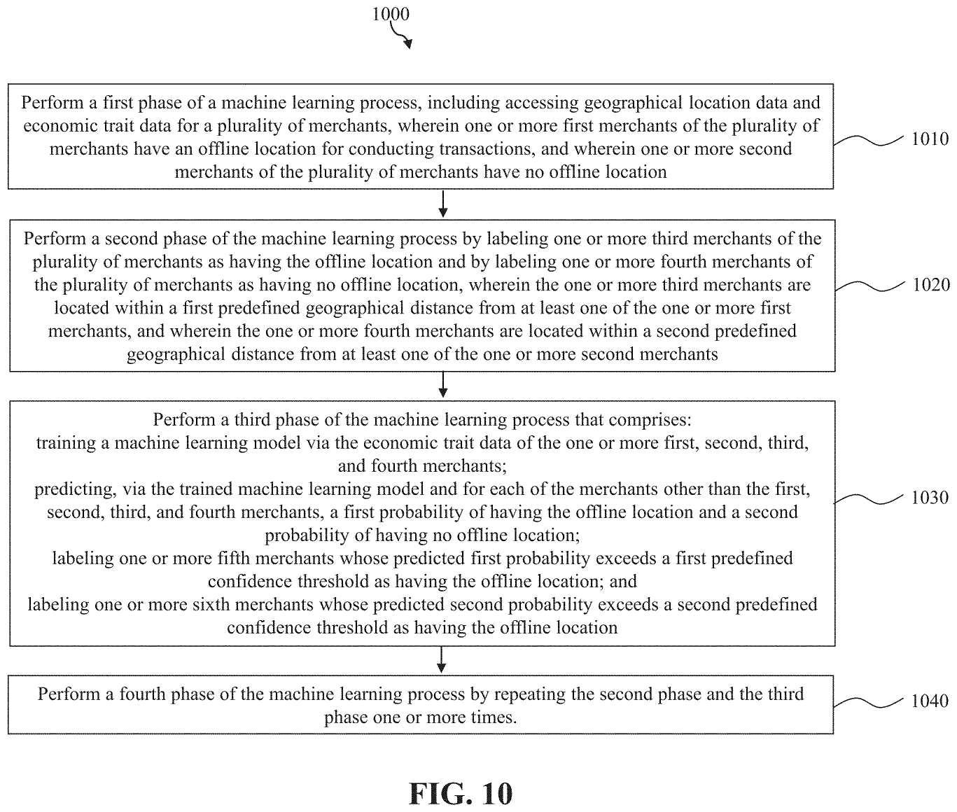

FIG. 10 is a flowchart illustrating a method 1000 for performing a machine learning process according to various aspects of the present disclosure. The various steps of the method 1000 may be performed by one or more electronic processors. In some embodiments, at least some of the steps of the method 1000 may be performed by the module 200 discussed above. Further, for conciseness, not all details associated with the steps below are included, as such details are discussed above, and thus, the steps described below include suitable descriptions above.

The method 1000 includes a step 1010 to perform a first phase of a machine learning process, including accessing geographical location data and economic trait data for a plurality of merchants. One or more first merchants of the plurality of merchants have an offline location for conducting transactions. One or more second merchants of the plurality of merchants have no offline location.

The method 1000 includes a step 1020 to perform a second phase of the machine learning process by labeling one or more third merchants of the plurality of merchants as having the offline location and by labeling one or more fourth merchants of the plurality of merchants as having no offline location. The one or more third merchants are located within a first predefined geographical distance from at least one of the one or more first merchants. The one or more fourth merchants are located within a second predefined geographical distance from at least one of the one or more second merchants.

The method 1000 includes a step 1030 to perform a third phase of the machine learning process. The third phase comprises: training a machine learning model via the economic trait data of the one or more first, second, third, and fourth merchants; predicting, via the trained machine learning model and for each of the merchants other than the first, second, third, and fourth merchants, a first probability of having the offline location and a second probability of having no offline location; labeling one or more fifth merchants whose predicted first probability exceeds a first predefined confidence threshold as having the offline location; and labeling one or more sixth merchants whose predicted second probability exceeds a second predefined confidence threshold as having the offline location.

The method 1000 includes a step 1040 to perform a fourth phase of the machine learning process by repeating the second phase and the third phase one or more times.

In some embodiments, the first phase of the machine learning process comprises labeling the one or more first merchants as having the offline location and labeling the one or more second merchants as having no offline location.

In some embodiments, the repeating the second phase comprises: labeling one or more seventh merchants of the plurality of merchants as having the offline location in response to the one or more seventh merchants being located within the first predefined geographical distance from at least one of the one or more first, third, or fifth merchants. In some embodiments, the repeating the second phase comprises: labeling one or more eighth merchants of the plurality of merchants as having no offline location in response to the one or more eighth merchants being located within the second predefined geographical distance from at least one of the one or more second, fourth, or sixth merchants.

In some embodiments, the repeating the third phase comprises: labeling one or more seventh merchants of the plurality of merchants as having the offline location in response to the predicted first probability of the one or more seventh merchants exceeding the first predefined confidence threshold. In some embodiments, the repeating the third phase comprises: labeling one or more eighth merchants of the plurality of merchants as having no offline location in response to the predicted second probability of the one or more eight merchants exceeding the second predefined confidence threshold.

In some embodiments, the fourth phase is performed until: every merchant of the plurality of merchants has been labeled as having the offline location or having no offline location; or no merchant can be labeled as one of the third or fourth merchants in the second phase of the machine learning process and no merchant can be labeled as one of the fifth or sixth merchants in the third phase of the machine learning process.

It is understood that additional method steps may be performed before, during, or after the steps 1010-1040 discussed above. For reasons of simplicity, other additional steps are not discussed in detail herein.

Based on the above discussions, it can be seen that the present disclosure offers several advantages over conventional methods and systems. It is understood, however, that not all advantages are necessarily discussed in detail herein, different embodiments may offer different advantages, and that no particular advantage is required for all embodiments. One advantage is improved functionality of a computer. For example, the module 200 expands the size of the training data by leveraging available geographical location data of entities such as merchants. As a result, the machine learning model may now be more accurately trained. Faster and more accurate results (e.g., predictions as to offline presence of merchants) may be obtained accordingly. The inventive ideas of the present disclosure are also integrated into a practical application, for example into the module 200, such that it may be used to expand the training data to make machine learning feasible/practical. The machine learning models may also accurately predict which merchants have offline locations, which can be used by transaction platforms and/or payment providers to prevent fraud or provide improved client services.

One aspect of the present disclosure involves a method. The method includes: accessing a geographical location and one or more attributes of each entity of a plurality of entities, wherein a first subset of the entities of the plurality of entities each have an offline presence, respectively, wherein a second subset of the entities of the plurality of entities each have no offline presence, and wherein a third subset of the entities of the plurality of entities each have an unknown offline presence; identifying, from the third subset of the entities and based on the accessing, one or more first entities having geographical locations within a predefined distance from the geographical location of any of the entities in the first subset of the entities, and one or more second entities having geographical locations within the predefined distance from the geographical location of any of the entities in the second subset of the entities; grouping the one or more identified first entities into the first subset of the entities and grouping the one or more identified second entities into the second subset of the entities; removing the one or more identified first entities and second entities from the third subset of the entities; thereafter training a machine learning model based on the one or more attributes; determining, via the machine learning model, a first probability and a second probability for each remaining entity in the third subset of the entities, the first probability corresponding to a probability of having the offline presence, the second probability corresponding to a probability of having no offline presence; identifying, from the third subset of the entities and based on the determined first probability and second probability, one or more third entities each having the determined first probability exceeding a first predefined threshold and one or more fourth entities each having the determined second probability exceeding a second predefined threshold; grouping the one or more identified third entities into the first subset of the entities and grouping the one or more identified fourth entities into the second subset of the entities; and removing the one or more identified third entities and fourth entities from the third subset of the entities.

Another aspect of the present disclosure involves a system that includes a non-transitory memory and one or more hardware processors coupled to the non-transitory memory and configured to read instructions from the non-transitory memory to cause the system to perform operations comprising: performing a first phase of a machine learning process, including accessing geographical location data and economic trait data for a plurality of merchants, wherein one or more first merchants of the plurality of merchants have an offline location for conducting transactions, and wherein one or more second merchants of the plurality of merchants have no offline location; performing a second phase of the machine learning process by labeling one or more third merchants of the plurality of merchants as having the offline location and by labeling one or more fourth merchants of the plurality of merchants as having no offline location, wherein the one or more third merchants are located within a first predefined geographical distance from at least one of the one or more first merchants, and wherein the one or more fourth merchants are located within a second predefined geographical distance from at least one of the one or more second merchants; performing a third phase of the machine learning process that comprises: training a machine learning model via the economic trait data of the one or more first, second, third, and fourth merchants; predicting, via the trained machine learning model and for each of the merchants other than the first, second, third, and fourth merchants, a first probability of having the offline location and a second probability of having no offline location; labeling one or more fifth merchants whose predicted first probability exceeds a first predefined confidence threshold as having the offline location; and labeling one or more sixth merchants whose predicted second probability exceeds a second predefined confidence threshold as having no offline location.

Yet another aspect of the present disclosure involves a non-transitory machine-readable medium having stored thereon machine-readable instructions executable to cause a machine to perform operations comprising: accessing geographical location data and non-geographical-location data of each merchant of a plurality of merchants, wherein a first subset of the merchants of the plurality of merchants each have an offline presence, respectively, wherein a second subset of the merchants of the plurality of merchants each have no offline presence, and wherein the offline presence is unknown for a third subset of the merchants of the plurality of merchants; identifying, from the third subset of the merchants and based on the accessing of the geographical location data, one or more first merchants that are each located within a first predefined proximity from any of the merchants in the first subset of the merchants, and one or more second merchants that are each located within a second predefined proximity from any of the merchants in the second subset of the merchants; labeling the one or more identified first merchants as belonging to the first subset of the merchants; labeling the one or more identified second merchants as belonging to the second subset of the merchants; training a machine learning model based on the non-geographical-location data of the first subset of the merchants and the second subset of the merchants; predicting, via the trained machine learning model, a first probability and a second probability for each remaining merchant in the third subset of the merchants, the first probability corresponding to a probability of having the offline presence, the second probability corresponding to a probability of having no offline presence; identifying, from the third subset of the merchants and based on the predicted first probability and the predicted second probability, one or more third merchants whose predicted first probability exceeds a first predefined threshold and one or more fourth merchants whose predicted second probability exceeds a second predefined threshold; labeling the one or more identified third merchants as belonging to the first subset of the merchants; and labeling the one or more identified fourth merchants as belonging to the second subset of the merchants.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing a geographical location and one or more attributes of each entity of a plurality of entities, wherein a first subset of the entities of the plurality of entities each have an offline presence, respectively, wherein a second subset of the entities of the plurality of entities each have no offline presence, and wherein a third subset of the entities of the plurality of entities each have an unknown offline presence;
identifying, from the third subset of the entities and based on the accessing, one or more first entities having geographical locations within a predefined distance from the geographical location of any of the entities in the first subset of the entities, and one or more second entities having geographical locations within the predefined distance from the geographical location of any of the entities in the second subset of the entities;
grouping the one or more identified first entities into the first subset of the entities and grouping the one or more identified second entities into the second subset of the entities;
removing the one or more identified first entities and second entities from the third subset of the entities;
training a machine learning model based on the one or more attributes;
determining, via the machine learning model, a first probability and a second probability for each remaining entity in the third subset of the entities, the first probability corresponding to a probability of having the offline presence, the second probability corresponding to a probability of having no offline presence;
identifying, from the third subset of the entities and based on the determined first probability and second probability, one or more third entities each having the determined first probability exceeding a first predefined threshold and one or more fourth entities each having the determined second probability exceeding a second predefined threshold;
grouping the one or more identified third entities into the first subset of the entities and grouping the one or more identified fourth entities into the second subset of the entities; and
removing the one or more identified third entities and fourth entities from the third subset of the entities.

2. The method of claim 1, further comprising, before the identifying the one or more first entities:
determining, via digital media of the first subset of the entities, that the first subset of entities each have the offline presence; or
determining, via digital media of the second subset of the entities, that the second subset of entities each have no offline presence.

3. The method of claim 1, further comprising, before the identifying the one or more first entities: determining, via one or more humans, that the first subset of entities each have the offline presence or that the second subset of entities each have no offline presence.

4. The method of claim 1, wherein the accessing comprises retrieving data pertaining to the geographical location and the one or more attributes from an electronic database.

5. The method of claim 1, wherein the plurality of entities comprises a plurality of merchants that each have at least an online presence.

6. The method of claim 5, wherein the offline presence is a physical location of a respective merchant of the plurality of merchants at which at least some transactions are conducted in person with customers of the respective merchant.

7. The method of claim 1, wherein the training is based on the one or more attributes of the first subset of the entities and the second subset of the entities but not based on the one or more attributes of the third subset of the entities.

8. The method of claim 1, further comprising: repeating the identifying the one or more first entities and the one or more second entities, the grouping the one or more identified first entities and the one or more identified second entities, the removing the one or more identified first entities and second entities, the training, the determining, the identifying the one or more third entities and the one or more fourth entities, the grouping the one or more identified third entities and fourth entities, and the removing the one or more identified third entities and fourth entities one or more times.

9. The method of claim 8, wherein the repeating is performed until:
every entity in the third subset of the entities has been grouped into the first subset of the entities or into the second subset of the entities; or
no first, second, third, or fourth entities can be identified from the third subset of the entities.

10. The method of claim 1, wherein the first predefined threshold is equal to the second predefined threshold.

11. The method of claim 1, wherein the one or more attributes comprise economic traits of each of the plurality of entities.

12. The method of claim 1, wherein at least the training the machine learning model is performed by one or more hardware processors.

13. A system, comprising:
a non-transitory memory; and
one or more hardware processors coupled to the non-transitory memory and configured to read instructions from the non-transitory memory to cause the system to perform operations comprising:
performing a first phase of a machine learning process, including accessing geographical location data and economic trait data for a plurality of merchants, wherein one or more first merchants of the plurality of merchants have an offline location for conducting transactions, and wherein one or more second merchants of the plurality of merchants have no offline location;
performing a second phase of the machine learning process by labeling one or more third merchants of the plurality of merchants as having the offline location and by labeling one or more fourth merchants of the plurality of merchants as having no offline location, wherein the one or more third merchants are located within a first predefined geographical distance from at least one of the one or more first merchants, and wherein the one or more fourth merchants are located within a second predefined geographical distance from at least one of the one or more second merchants;
performing a third phase of the machine learning process that comprises:
training a machine learning model via the economic trait data of the one or more first, second, third, and fourth merchants;
predicting, via the trained machine learning model and for each of the merchants other than the first, second, third, and fourth merchants, a first probability of having the offline location and a second probability of having no offline location;
labeling one or more fifth merchants whose predicted first probability exceeds a first predefined confidence threshold as having the offline location; and
labeling one or more sixth merchants whose predicted second probability exceeds a second predefined confidence threshold as having no offline location.

14. The system of claim 13, wherein the performing the first phase of the machine learning process comprises labeling the one or more first merchants as having the offline location and labeling the one or more second merchants as having no offline location.

15. The system of claim 13, wherein the operations further comprise: performing a fourth phase of the machine learning process by repeating the second phase and the third phase one or more times.

16. The system of claim 15, wherein the repeating the second phase comprises:
labeling one or more seventh merchants of the plurality of merchants as having the offline location in response to the one or more seventh merchants being located within the first predefined geographical distance from at least one of the one or more first, third, or fifth merchants; or
labeling one or more eighth merchants of the plurality of merchants as having no offline location in response to the one or more eighth merchants being located within the second predefined geographical distance from at least one of the one or more second, fourth, or sixth merchants.

17. The system of claim 15, wherein the repeating the third phase comprises:
labeling one or more seventh merchants of the plurality of merchants as having the offline location in response to the predicted first probability of the one or more seventh merchants exceeding the first predefined confidence threshold; or
labeling one or more eighth merchants of the plurality of merchants as having no offline location in response to the predicted second probability of the one or more eight merchants exceeding the second predefined confidence threshold.

18. The system of claim 15, wherein the fourth phase is performed until:
every merchant of the plurality of merchants has been labeled as having the offline location or having no offline location; or
no merchant can be labeled as one of the third or fourth merchants in the second phase of the machine learning process and no merchant can be labeled as one of the fifth or sixth merchants in the third phase of the machine learning process.

19. A non-transitory machine-readable medium having stored thereon machine-readable instructions executable to cause a machine to perform operations comprising:
accessing geographical location data and non-geographical-location data of each merchant of a plurality of merchants, wherein a first subset of the merchants of the plurality of merchants each have an offline presence, respectively, wherein a second subset of the merchants of the plurality of merchants each have no offline presence, and wherein the offline presence is unknown for a third subset of the merchants of the plurality of merchants;
identifying, from the third subset of the merchants and based on the accessing of the geographical location data, one or more first merchants that are each located within a first predefined proximity from any of the merchants in the first subset of the merchants, and one or more second merchants that are each located within a second predefined proximity from any of the merchants in the second subset of the merchants;
labeling the one or more identified first merchants as belonging to the first subset of the merchants;
labeling the one or more identified second merchants as belonging to the second subset of the merchants;
training a machine learning model based on the non-geographical-location data of the first subset of the merchants and the second subset of the merchants;
predicting, via the trained machine learning model, a first probability and a second probability for each remaining merchant in the third subset of the merchants, the first probability corresponding to a probability of having the offline presence, the second probability corresponding to a probability of having no offline presence;
identifying, from the third subset of the merchants and based on the predicted first probability and the predicted second probability, one or more third merchants whose predicted first probability exceeds a first predefined threshold and one or more fourth merchants whose predicted second probability exceeds a second predefined threshold;
labeling the one or more identified third merchants as belonging to the first subset of the merchants; and
labeling the one or more identified fourth merchants as belonging to the second subset of the merchants.

20. The non-transitory machine-readable medium of claim 19, wherein the operations further comprise: repeating the identifying the one or more first merchants and the one or more second merchants, the labeling the one or more identified first merchants, the labeling the one or more identified second merchants, the training the machine learning model, the predicting, the identifying the one or more third merchants and the one or more fourth merchants, the labeling the one or more identified third merchants, and the labeling the one or more identified fourth merchants one or more times until:
every merchant of the plurality of the merchants has been labeled as belonging to the first subset or to the second subset; or
no merchant of the plurality of the merchants can be labeled as belonging to the first subset or to the second subset.
